(19) United States
(12) Patent Application Publication
(10) Pub. No.: US 2019/0168377 A1
(43) Pub. Date: Jun. 6, 2019

(54) POST LOCK TOOL HOLDER FOR L-SHAPED WRENCHES

(71) Applicant: WAGIC, Inc., San Jose, CA (US)

(72) Inventors: Ronald L. Johnson, San Jose, CA (US); Yugen Patrick Lockhart, Palo Alto, CA (US)

(21) Appl. No.: 16/266,085

(22) Filed: Feb. 3, 2019

Related U.S. Application Data
(63) Continuation of application No. 14/918,155, filed on Oct. 20, 2015, now Pat. No. 10,239,197.
Application No. 14/918,155 is a division of application No. 13/835,387, filed on Mar. 15, 2013, now Pat. No. 9,193,062.

(51) Int. Cl. B25H 3/04; B65D 85/24; B25H 3/00; B25B 15/00

(52) U.S. Cl. CPC B25H 3/04; B25B 15/008; B25H 3/003; B65D 85/24

(57) ABSTRACT

A tool holder holds one or more tools when not being used. The tool holder comprises a body with a plurality of tool retainers for removably receiving a tool and a plurality of posts for securing the tool within the tool holder body when the tool holder is in a closed configuration. In some embodiments, the tool retainers are holding tubes, pockets or slots. In order to couple a tool with the tool holder, a lock door is moved to an open position and the tool is inserted into a tool retainer of the tool holder. Then the locked door is moved to a closed position where it is positioned over the tool and the tool is secured within the tool holder. The tool is securely held within the tool holder body and is not removable when the tool holder is in the closed position. In some embodiments, the tool holder is configured to hold a L-shaped hexagonal or round tool. In some embodiments, the tool holder is able to hold a plurality of tools of different sizes.

### FIELD OF THE INVENTION

The present invention relates to the field of hand held tools. More specifically, the present invention relates to the field of hexagonal wrenches and related tools and safety, comfort, and convenience of accessories and tools.

### BACKGROUND OF THE INVENTION

Hexagonal wrenches or tool drivers, also referred to as allen wrenches or L-wrenches, have a hexagonal L-shaped body, including a long leg member and a short leg member. The end of either leg member is able to be inserted into a head of a screw or tool designed to accept a hexagonal wrench. Hexagonal wrenches are manufactured and distributed in multiple English and metric sizes in order to facilitate their use with screw heads of multiple sizes. Such wrenches are usually sold in a set which includes wrenches of multiple sizes but are also distributed individually.

When using a hexagonal wrench, a user, will insert an end of the hexagonal wrench into the head of a workpiece such as a screw, and will then exert rotational pressure on the opposite end of the wrench in order to tighten or loosen the screw. Multiple sizes of hexagonal wrenches are often used together in order to complete a task. Consequently, it is convenient to store multiple tools of different sizes in a common location.

### SUMMARY OF THE INVENTION

A tool holder holds one or more tools when not being used. The tool holder comprises a body with a plurality of tool retainers for removably receiving a tool and a plurality of posts for securing the tool within the tool holder body when the tool holder is in a closed configuration. In some embodiments, the tool retainers are holding tubes, pockets or slots. In order to couple a tool with the tool holder, a lock door is moved to an open position and the tool is inserted into a tool retainer of the tool holder. Then the locked door is moved to a closed position where it is positioned over the tool and the tool is secured within the tool holder. The tool is securely held within the tool holder body and is not removable when the tool holder is in the closed position. In some embodiments, the tool holder is configured to hold a L-shaped hexagonal or round tool. In some embodiments, the tool holder is able to hold a plurality of tools of different sizes.

In one aspect, a tool holder comprises a tool holder body comprising one or more tool retainers, a lock door movable between an open position and a closed position, and a back panel. In some embodiments, the tool holder is configured for holding a L-shaped round or hexagonal tool. In order to couple a L-shaped tool with the tool holder a long leg of the tool is inserted into one of the one or more of the tool retainers. In some embodiments, when the tool is coupled with the tool holder, the short leg of the tool extends at a 90° orientation with respect to the retainer and the long leg of the tool extends from a bottom of the tool retainer. In some embodiments, the tool is prevented from being removed from the tool retainer when the lock door is in the closed position independent of a vacancy of one or more neighboring tool retainers. In some embodiments, the lock door moves to the open position by rotating away from the back panel and about a hinge. In some of these embodiments, the hinge comprises a pivot pin, slide, access or clip. In further embodiments, the lock door is removed from, slid, and/or retracted from the back panel in order to move to the open position. In some embodiments, the one or more tool retainers are configured to each hold one or more tools of different sizes. In some embodiments, the one or more tool retainers are arranged in a single row, multiple rows, over laid side-by-side, or front to back. In some embodiments, the one or more tool retainers comprise holding tubes, pockets or slots. In further embodiments, the tool holder comprises one or more posts that secure a L-shaped tool in place in order to prevent the tool from being removed when the lock door is in the closed position. In still further embodiments, the tool holder comprises one or more securing protrusions that secure the L-shaped tool in place in order to prevent them from being removed when the lock door is in the closed position. In some embodiments, the one or more securing protrusions interlock with the back panel in order to snap fit to the back panel and secure the lock door into place. In further embodiments, the tool holder further comprises a lock that secure the lock door into place.

In another aspect, a tool for holding a plurality of tools comprises a tool holder body comprising a plurality of tool retainers, each for removably holding a tool and a lock door movable between an open position and a closed position, wherein when a tool is coupled with a retainer, the tool is prevented from being removed from the tool retainer when the lock door is in the closed position independent of a vacancy of one or more neighboring tool retainers. In some embodiments, the tool holder is configured for holding a L-shaped round or hexagonal tool. In order to couple a L-shaped tool with the tool holder a long leg of the tool is inserted into one of the plurality of tool retainers. In some embodiments, when a tool is coupled with the tool holder, the short leg of the tool extends at a 90° orientation with respect to the holding tube and the long leg of the tool extends from a bottom of the tool retainer. In some embodiments, the lock door moves to the open position by rotating away from the back panel and about a hinge. In some of these embodiments, the hinge comprises a pivot pin, slide, access or clip. In further embodiments, the lock door is removed from, slid, and/or retracted from the back panel in order to move to the open position. In some embodiments, the plurality of tool retainers are configured to each hold a tool of different sizes. In some embodiments, the plurality of tool retainers are arranged in a single row, multiple rows, over laid side-by-side, or front to back. In some embodiments, the plurality of tool retainers comprise holding tubes, pockets or slots. In some embodiments, the tool holder further comprises one or more posts that secure a L-shaped tool in place in order to prevent the tool from being removed when the lock door is in the closed position. In further embodiments, the tool holder further comprises one or more securing protrusions that secure the L-shaped tool in place in order to prevent them from being removed when the lock door is in the closed position. In some of these embodiments, the one or more securing protrusions interlock with the back panel in order to snap fit to the back panel and secure the lock door into place. In some embodiments, the tool holder further comprises a lock that secure the lock door into place. In further embodiments, the tool holder comprises a first set of holding tubes and a second set of retainers.

In still further embodiments, a method of removably securing a L-shaped tool with a tool holder comprises moving a lock door to an open position, inserting one or more L-shaped tools into one or more tool retainers of the tool holder and moving the lock door to a close position in order to secure one or more tools within the one or more tool retainers. In some embodiments, the lock door moves to the open position by rotating away from the back panel about a hinge. In some embodiments, the one or more tool retainers are configured to each hold a tool of different sizes. In some embodiments, a tool is prevented from being removed from the tool retainer when the lock door is in the closed position independent of a vacancy of one or more neighboring tool retainers. In some embodiments, the one or more tool retainers comprise holding tubes, pockets or slots.

### BRIEF DESCRIPTION OF THE DRAWINGS

FIG. 1 illustrates a tool holder for holding a tool in accordance with some embodiments.

FIG. 2 illustrates a tool holder in an open configuration in accordance with some embodiments.

FIGS. 3A and 3B illustrate a tool holder holding a plurality of tools in accordance with some embodiments.

FIGS. 4A and 4B illustrate a tool holder holding a plurality of tools in accordance with some embodiments.

FIG. 5 illustrates a method of removably coupling a tool with a tool holder in accordance with some embodiments.

### DETAILED DESCRIPTION OF THE PREFERRED EMBODIMENT

The description below concerns several embodiments of the invention. The discussion references the illustrated preferred embodiment. However, the scope of the present invention is not limited to either the illustrated embodiment, nor is it limited to those discussed, to the contrary, the scope should be interpreted as broadly as possible based on the language of the Claims section of this document.

This disclosure provides several embodiments of the present invention. It is contemplated that any features from any embodiment can be combined with any features from any other embodiment. In this fashion, hybrid configurations of the illustrated embodiments are well within the scope of the present invention.

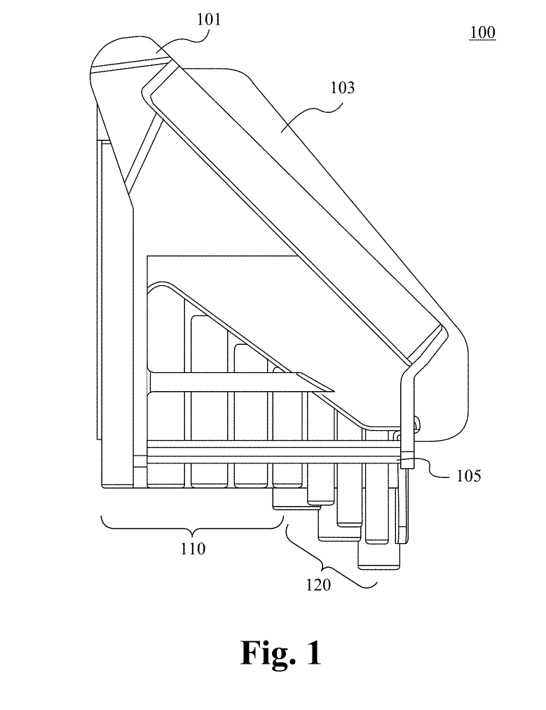

Referring now to FIG. 1, a first embodiment of a tool holder is depicted therein. The tool holder 100 comprises a tool holder body having a lock door 101, a back panel 103 and a hinge 105. As shown in FIG. 1, the tool holder 100 further comprises a first set of tool retainers 110 and a second set of tool retainers 120. In some embodiments, the tool retainers are holding tubes, pockets or slots. As will be apparent to someone of ordinary skill in the art, the tool holder 100 is able to comprise any number of sets of tool retainers and any number of tool retainers, including one. In some embodiments, the sets of tool retainers are arranged in an overlapping configuration. However, the tool retainers are able to be arranged in any desired configuration. For example, in some embodiments, the tool retainers are arranged in a single row, multiple rows, over laid out side-by-side, or front to back.

The tool holder 100 is configured for holding one or more L-shaped tools within the tool retainers. The L-shaped tool is able to have any shape including hexagonal, round, or any other appropriate shape. In some embodiments, each tool retainer is of a size and a dimension which corresponds to one or more tool sizes. In some embodiments, the tool storage tubes are configured for holding a plurality of tools of different sizes.

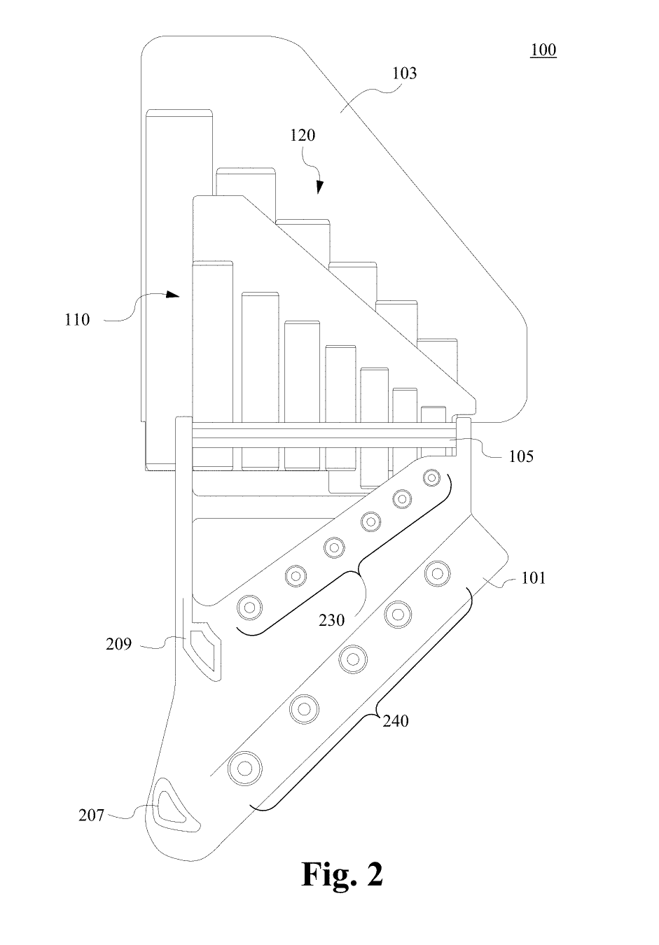

FIG. 2 illustrates a tool holder in an open configuration in accordance with some embodiments. The tool holder 200 is similar to the tool holder 100 as described in relation to FIG. 1 and comprises a tool holder body having a lock door 201, a back panel 203, and a hinge 205. The tool holder body also comprises a first set of a first set of tool retainers 210 and a second set of tool retainers 220. In some embodiments, the tool retainers are holding tubes, pockets or slots. As shown within FIG. 2, the lock door 201 has been opened by rotating the lock door 201 away from the back panel 203 about the hinge 205 and placed in the open position. In some embodiments, the hinge 205 comprises a pivot pin in order to rotate the lock door to the open position. In some embodiments, the lock door 201 is removed, slid, and/or retracted in order to access the first set of tool retainers 210 and the second set of tool retainers 220.

As further shown in FIG. 2, the inside of the lock door 201 comprises a first set of posts 230 and a second set of posts 240 and one or more securing protrusions 207 and 209. In some embodiments, the number of posts is the same as the number of tool retainers. The first set of posts 230, the second set of posts 240 and the one or more securing protrusions 207 and 209 help secure a L-shape tool in place when it is coupled with the tool handle 200 and the lock door 201 is placed in a closed position. In some embodiments, the one or more securing protrusions 207 and 209 interlock with the back panel 203 in order to snap fit to the back panel and secure the lock door 201 into place. Although two securing protrusions are shown in FIG. 2, as will be apparent to someone of ordinary skill in the art, the tool holder 200 is able to comprise any number of securing protrusions.

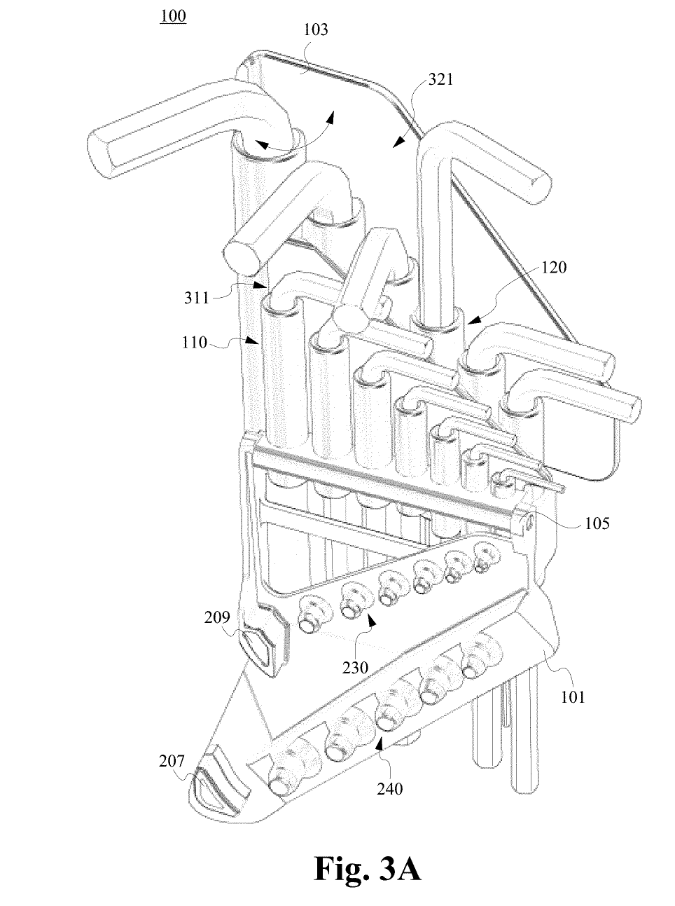

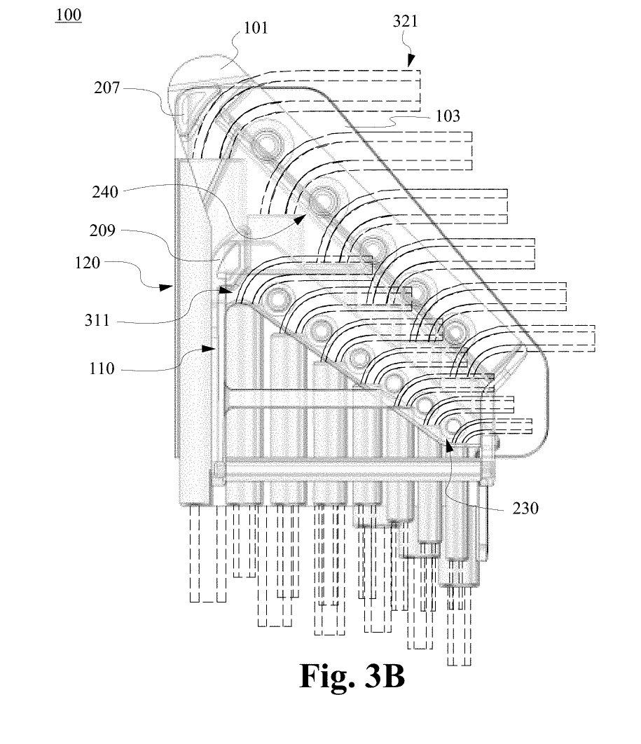

FIGS. 3A and 3B illustrate a tool holder coupled with a plurality of tools in accordance with some embodiments. The tool holder 300 is similar to the tool holder 100 as described in relation to FIG. 1 and comprises a tool holder body having a lock door 301, a back panel 303, and a hinge 305. The tool holder body also comprises a first set of a first set of tool retainers 310 and a second set of tool retainers 320. In some embodiments, the tool retainers are holding tubes, pockets or slots. As shown in FIGS. 3A and 3B, a first set of tools 311 has been inserted into the first set of tool retainers 310 and a second set of tools 321 has been inserted into the second set of tool retainers 320. Although the plurality of tool retainers are all shown coupled with a tool, the tool holder is able to be used without tools in all of the tool retainers depending on the desired use of the tool holder.

In order to removably couple a L-shaped tool with the tool holder 300, a long leg of the L-shaped tool is placed within a correspondingly sized tool retainer. When the long leg of the L-shaped tool is in the tool retainer, the short leg of the tool extends at a 90° orientation with respect to the tool retainer. In some embodiments, when the tool is held within the tool holder, the short leg of the tool extends parallel to and against the back panel 303. In some embodiments, when the tool is held within the tool holder, the short leg of the tool is not parallel to the back panel 303. As seen within FIG. 3A, in some embodiments, when a plurality of tools are coupled with the tool handle 300 and the short leg of the tool extends parallel to and against the back panel 303, the plurality of short legs of each tool overlap each other. Consequently, in some embodiments, in order to insert and/or remove a tool from one of the tool retainers, one or more tools is rotated as indicated by the arrow so that the short leg of the tool is perpendicular to the back panel 303. In this configuration, the tool is able to easily be inserted and/or removed from the tool holder 300. As further shown within FIG. 3A, when a L-shaped tool is coupled with the tool handle 300, the long leg of the tool extends from a bottom of the tool retainer.

FIG. 3B shows the tool holder 300 coupled with a plurality of tools and the lock door 301 in a closed configuration in accordance with some embodiments. FIG. 3B, is drawn in order to show the interaction of the first set of posts 330 and the securing protrusion 309 with the first set of tools 311 and the interaction of the second set of posts 340 and the securing protrusion 307 with the second set of tools 321 when the tools are removably coupled with the tool holder 300 and the lock door 301 is placed in a closed position. As described above, in order to removably couple a L-shaped tool with the tool holder 300, a long leg of the L-shaped tool is placed within a correspondingly sized tool retainer.

As shown within FIG. 3B, when one or more tools is removably coupled with the tool holder and the lock door 301 is in the closed position, the one or more tools are held in place by the interaction of the tool retainers, the posts, the securing protrusions, and the lock door with the one or more tools. Particularly, when the lock door 301 is closed, the L-shaped tools are retained in a compact and orderly manner, which prevents them from sliding or escaping from their individual storage positions, regardless of any vacant neighboring tool storage retainers.

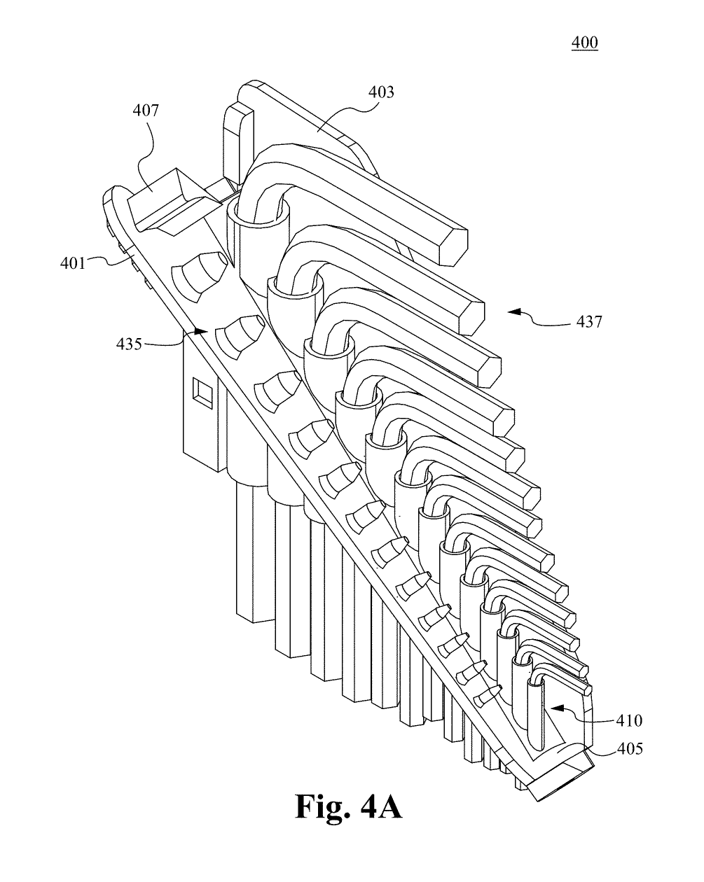

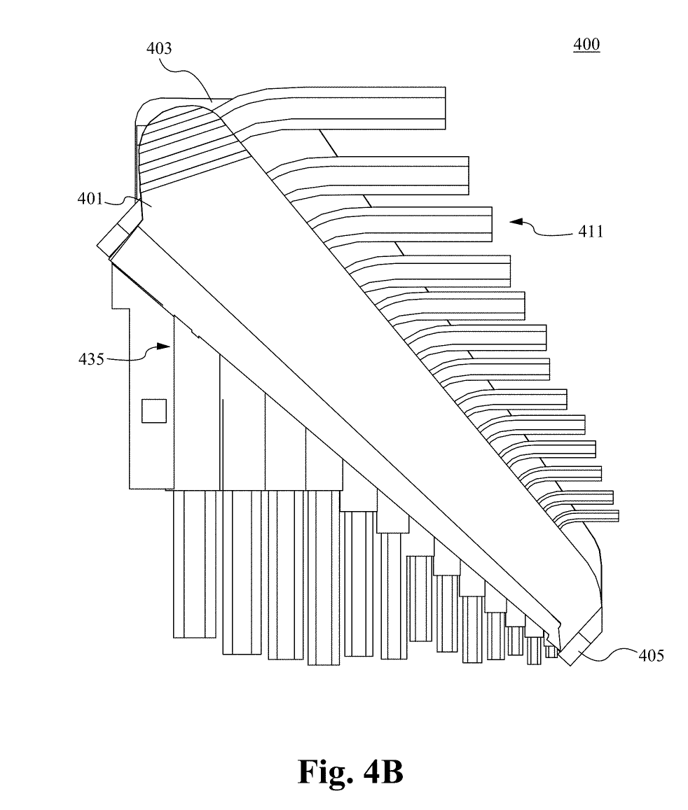

FIGS. 4A and 4B illustrate a tool holder in accordance with further embodiments. The tool holder 400 comprises a tool holder body having a lock door 401, a back panel 403, and a hinge 405. The tool holder body also comprises a plurality of tool retainers 435 for holding a plurality of tools 437. In some embodiments, the tool retainers are holding tubes, pockets or slots. The tool holder 400 shows the plurality of tool retainers 435 arranged in a single row. However, as described above, the tool retainers 435 are able to be arranged in any appropriate desired configuration.

In order to removably couple a L-shaped tool with the tool holder 400, a long leg of the L-shaped tool is placed within a correspondingly sized tool retainer. When the long leg of the L-shaped tool is in the tool retainer, the short leg of the tool extends at a 90° orientation with respect to the tool retainer. In some embodiments, when the tool is held within the tool holder, the short leg of the tool extends parallel to and against the back panel 403. In some embodiments, when the tool is held within the tool holder, the short leg of the tool is not parallel to the back panel 403. As seen within FIG. 4A, in some embodiments, when a plurality of tools are coupled with the tool holder 400 and the short leg of the tool extends parallel to and against the back panel 403, the plurality of short legs of each tool overlap each other. Consequently, in some embodiments, in order to insert and/or remove a tool from one of the tool retainers, one or more tools is rotated so that the short leg of the tool is perpendicular to its closed door or locked position and the back panel 403. In this configuration, the tool is able to be easily inserted and/or removed from the tool holder 400. As further shown within FIG. 3A, when a L-shaped tool is coupled with the tool holder 400, the long leg of the tool extends from a bottom of the tool retainer.

FIG. 4B shows the tool holder 400 coupled with a plurality of tools and the lock door 401 in a closed configuration in accordance with some embodiments. FIG. 4B, is drawn in order to show the interaction of the first set of posts 440 and the securing protrusion 409 with the first set of tools 411 and the interaction of the second set of posts 440 and the securing protrusion 407 with the second set of tools 421 when the tools are removably coupled with the tool holder 400 and the lock door 401 is placed in a closed position. As described above, in order to removably couple a L-shaped tool with the tool holder 400, a long leg of the L-shaped tool is placed within a correspondingly sized tool retainer.

As shown within FIG. 4B, when one or more tools is removably coupled with the tool holder and the lock door 401 is in the closed position, the one or more tools are held in place by the interaction of the tool retainers, the posts, the securing protrusions, and the lock door with the one or more tools. Additionally, when the lock door 401 is closed, the L-shaped tools are retained in a compact and orderly manner, which prevents them from sliding or escaping from their individual storage positions, regardless of the vacant neighboring tool storage tube slots.

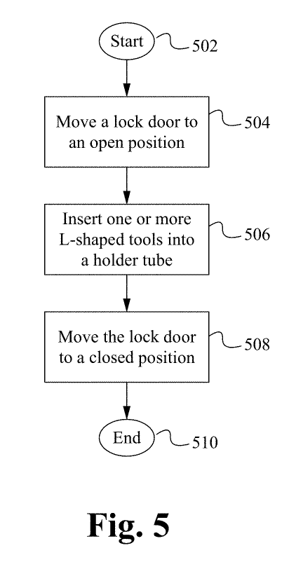

FIG. 5 illustrates a method of removably coupling a L-shaped tool with a tool holder in accordance with some embodiments. In the step 504, a lock door of the tool holder is moved to an open position. In some embodiments, the lock door is moved to the open position by rotating it about a hinge to an open position. In some embodiments, the lock door is moved to the open position by removing it from the tool holder, sliding the lock door and/or retracting it. In the step 506, one or more L-shaped tools is inserted into a tool retainer of the tool holder. In some embodiments, the tool retainers are holding tubes, pockets or slots. Then, in the step 508, the lock door is moved to a closed position. With the lock door in the closed position, the one or more tools is securely held within the tool holder and prevented from being removed.

In some embodiments, the tool holder is designed to be utilized with hexagonal wrenches of English sizes within the range of 0.050 inches to ⅜ inches, including a 0.050 inch hexagonal wrench, a 1/16 inch hexagonal wrench, a 5/64 inch hexagonal wrench, a 3/32 inch hexagonal wrench, a 7/64 inch hexagonal wrench, a ⅛ inch hexagonal wrench, a 9/64 inch hexagonal wrench, a 5/32 inch hexagonal wrench, a 3/16 inch hexagonal wrench, a 7/32 inch hexagonal wrench, a ¼ inch hexagonal wrench, a 5/16 inch hexagonal wrench and a ⅜ inch hexagonal wrench.

In some embodiments, the tool holder is also designed to be utilized with hexagonal wrenches of metric sizes within the range of 1.7 mm to 10 mm, including a 1.7 mm hexagonal wrench, an 2 mm hexagonal wrench, a 2.5 mm hexagonal wrench, a 3 mm hexagonal wrench, a 3.5 mm hexagonal wrench, a 4 mm hexagonal wrench, a 4.5 mm hexagonal wrench, a 5 mm hexagonal wrench, a 5.5 mm hexagonal wrench, a 6 mm hexagonal wrench, a 7 mm hexagonal wrench, a 8 mm hexagonal wrench, a 9 mm hexagonal wrench and a 10 mm hexagonal wrench.

In further embodiments, the tool holder is designed to be utilized with star shaped wrenches of sizes within the range of T-6 to T-50.

Alternatively, the tool holder for multiple tools of different sizes is able to be used with tools other than hexagonal wrenches and star wrenches.

The tool holder is able to be composed of any appropriate material, which is of maximum strength and includes properties which resist materials that the holder will likely be exposed to, e.g., oil, grease, gasoline and the like. In some embodiments, the tool holder is materially composed of a variety of resin polymer and copolymer compositions including fillers and reinforcing materials such as glass in order to meet the strength and chemical resistance requirements of the tool. In some embodiments, the tool holder is materially composed of any suitable composition including, but not limited to aluminum or steel. In some embodiments, the tools are materially composed of aluminum, steel or any other appropriate material.

In some embodiments, the tool holder is constructed using an injection molded, core/cavity process as is well known in the art. Alternatively, the tool handle is able to be constructed in any known manner.

Throughout this description, the term tool retainers has been used to describe certain embodiments. The tool retainers, as herein described, in some embodiments are able to be tubes, pockets or slots for holding the tools.

To utilize the tool holder, one or more tools are inserted into one or more tool retainers of the tool holder body. In some embodiments, the tool retainers are holding tubes, pockets or slots. In some embodiments, the tool is a L-shaped hexagonal or round tool. Once the tool is positioned and held within the tool holder, a user is able to easily close the lock door in order to secure to the tool within the tool holder. One or more L-shaped tools are able to be retained in a compact and orderly manner, while being prevented from sliding or escaping from their individual storage positions, regardless of the vacancy of the neighboring tool storage tube slots. In this manner, one or more different sized tools are able to be easily coupled with and removed from the tool holder and stored together in a compact manner.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the appended claims.

1-39. (canceled)

40. A tool holder comprising:
a. a tool holder body comprising;
i. a plurality of tool retainers each tool retainer for holding a tool of a plurality of tools; and
ii. a lock door movable about a pivot pin to an open position and about the pivot pin to a closed position to secure each tool of the plurality of tools within the tool retainers.

41. The tool holder of claim 40, wherein the tool holder is configured for holding an L-shaped round or hexagonal tool.

42. The tool holder of claim 40, wherein the one or more tool retainers are configured to each hold a tool of different size.

43. The tool holder of claim 40, wherein when the tool is coupled with the tool holder, a short leg of the tool extends at a 90° orientation with respect to the one of the one or more tool retainers and the long leg of the tool extends from a bottom of the one of the one or more tool retainers.

44. The tool holder of claim 40, wherein the tool is prevented from being removed from the one of the one or more tool retainers when the lock door is in the closed position independent of a vacancy of one or more neighboring tool retainers to the one of the one or more tool retainers.

45. The tool holder of claim 40, wherein the lock door moves to the open position by rotating away from the back panel.

46. The tool holder of claim 40, wherein the plurality of tool retainers are arranged in one of a single row and multiple rows.

47. The tool holder of claim 40, wherein the plurality of tool retainers comprise holding tubes, pockets or slots.

48. The tool holder of claim 40, wherein one or more posts secure a tool in place in order to prevent the tool from being removed when the lock door is in the closed position.

49. A tool holder for removably securing a L-shaped tool comprising:
a. a tool holder body comprising:
i. one or more tool retainers each tool retainer for securing a L-shaped tool; and
ii. a lock door movable about a pivot pin to an open position and about the pivot pin to a closed position to secure the L-shaped tools within the one or more tool retainers.

50. The tool holder of claim 49, wherein one or more securing protrusions interlock with a back panel in order to snap fit to the back panel and secure the lock door into place.

51. The tool holder of claim 49, wherein the tool holder further comprises a lock that secures the lock door into place.

52. The tool holder of claim 49, wherein the one or more tool retainers are configured to each hold a tool of different size.

53. The tool holder of claim 49, wherein in order to couple the L-shaped tool with the tool holder a long leg of the tool is inserted into one of the one or more tool retainers.

54. The tool holder of claim 53, wherein when the tool is coupled with the tool holder, a short leg of the tool extends at a 90° orientation with respect to the one of the one or more tool retainers and the long leg of the tool extends from a bottom of the one of the one or more tool retainers.

55. The tool holder of claim 49, wherein the tool is prevented from being removed from the one of the one or more tool retainers when the lock door is in the closed position independent of a vacancy of one or more neighboring tool retainers to the one of the one or more tool retainers.

56. The tool holder of claim 49, wherein the lock door moves to the open position by rotating away from the back panel.

57. The tool holder of claim 49, wherein the one or more tool retainers are arranged in one of a single row and multiple rows.

58. The tool holder of claim 49, wherein the one or more tool retainers comprise holding tubes, pockets or slots.

59. A tool holder for holding a plurality of tools comprising:
a. a tool holder body comprising a plurality of tool retainers, each tool retainer for removably holding a tool; and
b. a lock door, separable from the tool holder body, comprising one or more posts movable between an open position and a closed position to secure the tool held within the tool retainers in place to prevent the tool from being removed when the lock door is in the closed position, wherein the one or more posts fit between the tool retainers when the lock door is in the closed position.

60. The tool holder of claim 59, wherein the tool holder is configured for holding an L-shaped round or hexagonal tool.

61. The tool holder of claim 60, wherein in order to couple an L-shaped tool with the tool holder a long leg of the tool is inserted into one of the plurality of tool retainers.

62. The tool holder of claim 61, wherein when the L-shaped tool is coupled with the tool holder, a short leg of the tool extends at a 90° orientation with respect to the holding tube and the long leg of the tool extends from a bottom of the one of the one or more tool retainers.

63. The tool holder of claim 59, wherein the lock door moves to the open position by rotating away from the back panel and about a hinge.

64. The tool holder of claim 63, wherein the hinge comprises a pivot pin.

65. The tool holder of claim 59, wherein the plurality of tool retainers are arranged in one of a single row and multiple rows.

66. The tool holder of claim 59, wherein the one or more tool retainers comprise holding tubes, pockets or slots.

67. The tool holder of claim 59, wherein one or more securing protrusions interlock with a back panel in order to snap fit to the back panel and secure the lock door into place.

68. The tool holder of claim 59, wherein the tool holder further comprises a lock that secures the lock door into place.
